(19) United States
(12) Patent Application Publication
(10) Pub. No.: US 2026/0289732 A1
(43) Pub. Date: Sep. 24, 2026

(54) METHOD OF GENERATING IMAGE AND DEVICE FOR PERFORMING THE SAME

(71) Applicant: Electronics and Telecommunications Research Institute, Daejeon (KR)

(72) Inventor: KIHONG SON, Sejong-si (KR)

(21) Appl. No.: 19/534,602

(22) Filed: Feb. 9, 2026

(30) Foreign Application Priority Data
Mar. 19, 2025 (KR) 10-2025-0035109

(51) Int. Cl. G06T 5/50; G06T 5/10; G06T 5/60; G06T 5/70; G06T 5/73; G06T 7/55

(52) U.S. Cl. CPC G06T 5/50; G06T 5/10; G06T 5/60; G06T 5/70; G06T 5/73; G06T 7/55; G06T 2207/10112; G06T 2207/20056; G06T 2207/20064; G06T 2207/20084

(57) ABSTRACT

A method of generating an image is provided. The method includes obtaining depth information for a plurality of single-focus images, obtaining depth-wise focus information for the plurality of single-focus images based on the depth information, and generating a multi-focus image for the plurality of single-focus images based on the depth-wise focus information.

### CROSS-REFERENCE TO RELATED APPLICATIONS

This application claims the benefit of Korean Patent Application No. 10-2025-0035109, filed on Mar. 19, 2025, in the Korean Intellectual Property Office, the entire disclosure of which is incorporated herein by reference for all purposes.

### BACKGROUND

### 1. Field of the Invention

One or more embodiments relate to a method of generating an image and a device for performing the same.

### 2. Description of the Related Art

Digital tomosynthesis (DTS) technology may have advantages over computed tomography (CT) technology, including lower radiation exposure and faster scanning speeds. The DTS technology may be widely used in medical imaging and industrial inspection. However, the DTS technology may only generate cross-sectional images of a specific depth by combining images captured from a limited number of angles. Consequently, the DTS technology may have limitations in expressing a three-dimensional structure or reducing image resolution.

The above description has been possessed or acquired by the inventor(s) in the course of conceiving the present disclosure and is not necessarily an art publicly known before the present application is filed.

### SUMMARY

Embodiments provide obtaining depthwise focus information based on a plurality of single-focus images.

Embodiments provide generating a multi-focus image based on depthwise focus information.

Embodiments provide a multi-focus image having image quality similar to a computed tomography (CT) image.

However, the technical aspects are not limited to the aforementioned aspects, and other technical aspects may be present.

According to an aspect, there is provided a method of generating an image, the method including obtaining depth information for a plurality of single-focus images, obtaining depthwise focus information for the plurality of single-focus images based on the depth information, and generating a multi-focus image for the plurality of single-focus images based on the depthwise focus information.

The obtaining of the depth information for the plurality of single-focus images may include extracting a spatial feature from the plurality of single-focus images by inputting the plurality of single-focus images to a deep convolutional neural network (CNN) model and obtaining the depth information for the plurality of single-focus images based on the spatial feature.

The obtaining of the depthwise focus information for the plurality of single-focus images based on the depth information may include obtaining the depthwise focus information by applying a Fourier transform and a wavelet transform to the depth information.

The generating may include generating the multi-focus image by inputting the depthwise focus information to a CNN-based diffusion model.

Each of the plurality of single-focus images may be captured from a different angle of a captured subject.

The plurality of single-focus images may be digital tomosynthesis (DTS) images.

The method may further include preprocessing the plurality of single-focus images by removing blur and noise of the plurality of single-focus images.

The method may further include removing blur and noise of the multi-focus image.

According to another aspect, there is provided an electronic device for generating an image, the electronic device including a processor and a memory configured to store instructions, wherein the instructions, when executed by the processor, may cause the electronic device to obtain depth information for a plurality of single-focus images, obtain depthwise focus information for the plurality of single-focus images based on the depth information, and generate a multi-focus image for the plurality of single-focus images based on the depthwise focus information.

The instructions may cause the electronic device to extract a spatial feature from the plurality of single-focus images by inputting the plurality of single-focus images to a deep CNN model and obtain the depth information for the plurality of single-focus images based on the spatial feature.

The instructions may cause the electronic device to obtain the depthwise focus information by applying a Fourier transform and a wavelet transform to the depth information.

The instructions may cause the electronic device to generate the multi-focus image by inputting the depthwise focus information to a CNN-based diffusion model.

Each of the plurality of single-focus images may be captured from a different angle of a captured subject.

The plurality of single-focus images may be DTS images.

The instructions may cause the electronic device to preprocess the plurality of single-focus images by removing blur and noise of the plurality of single-focus images.

The instructions may cause the electronic device to remove blur and noise of the multi-focus image.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a device for generating an image, according to an embodiment;

FIG. 2 is a diagram illustrating a capturing system using digital tomosynthesis (DTS) technology, according to an embodiment;

FIG. 3 is a diagram illustrating a DTS image according to an embodiment;

FIG. 4 is a diagram illustrating a method of generating a multi-focus image, according to an embodiment;

FIG. 5 is a diagram illustrating an image generation module according to an embodiment;

FIG. 6 is a diagram illustrating a DTS image and a computed tomography (CT) image according to an embodiment;

FIG. 7 is a flowchart illustrating a method of generating an image according to an embodiment;

FIG. 8 is a flowchart illustrating a method of obtaining depth information for a plurality of single-focus images, according to an embodiment; and

FIG. 9 is a flowchart illustrating a method of generating a multi-focus image, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being "connected", "coupled", or "joined" to another component, a third component may be "connected", "coupled", and "joined" between the first and second components, although the first component may be directly connected, coupled, or joined to the second component.

The singular forms "a", "an", and "the" are intended to include the plural forms as well, unless the context clearly indicates otherwise. As used herein, "A or B", "at least one of A and B", "at least one of A or B", "A, B or C", "at least one of A, B and C", and "at least one of A, B, or C," each of which may include any one of the items listed together in the corresponding one of the phrases, or all possible combinations thereof. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Hereinafter, the embodiments are described in detail with reference to the accompanying drawings. When describing the embodiments with reference to the accompanying drawings, like reference numerals refer to like components, and any repeated description related thereto will be omitted.

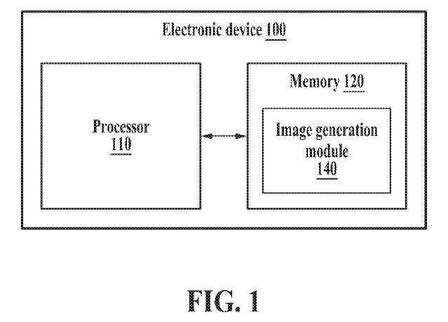

FIG. 1 is a diagram illustrating a device for generating an image, according to an embodiment.

Referring to FIG. 1, according to an embodiment, an electronic device 100 may be a device for generating an image. The electronic device 100 may include a processor 110 and a memory 120.

The processor 110 may process data stored in the memory 120. The processor 110 may execute computer-readable code (e.g., software) stored in the memory 120 and instructions triggered by the processor 110.

The processor 110 may be a hardware-implemented data processing device including a circuit having a physical structure to execute desired operations. The desired operations may include, for example, code or instructions included in a program.

The hardware-implemented data processing device may include, for example, a microprocessor, a central processing unit (CPU), a processor core, a multi-core processor, a multiprocessor, an ASIC, and a field-programmable gate array (FPGA).

The processor 110 may cause the electronic device 100 to perform one or more operations by executing the code and/or instructions stored in the memory 120.

The memory 120 may store instructions (or programs) executable by the processor 110. For example, the instructions may include instructions for executing the operation of the processor 110 and/or the operation of each component of the processor 110.

The memory 120 may include one or more of computer-readable storage media. The memory 120 may include non-volatile storage elements (e.g., a magnetic hard disc, an optical disc, a floppy disc, flash memory, electrically programmable memory (EPROM), and electrically erasable and programmable memory (EEPROM)).

The memory 120 may be a non-transitory medium. The term "non-transitory" may indicate that a storage medium is not embodied in a carrier wave or a propagated signal. However, the term "non-transitory" should not be interpreted to mean that the memory 120 is non-movable.

The memory 120 may include an image generation module 140. The image generation module 140 may obtain a plurality of single-focus images. The image generation module 140 may generate a multi-focus image. For example, the image generation module 140 may generate the multi-focus image based on the plurality of single-focus images. Specifically, the image generation module 140 may generate the multi-focus image based on the plurality of single-focus images to minimize blur at a peripheral plane of the plurality of single-focus images. The peripheral plane of the plurality of single-focus images may refer to a slice corresponding to a depth different from a focal plane (or a specific depth) of the plurality of single-focus images. The image generation module 140 may generate the multi-focus image based on the plurality of single-focus images to clearly restore the structure of a captured subject. Specifically, the image generation module 140 may generate the multi-focus image by inputting the plurality of single-focus images to a trained deep convolutional neural network (CNN) model, a trained CNN-based diffusion model, etc. The plurality of single-focus images may be digital tomosynthesis (DTS) images. The multi-focus image may be an image for improving image quality of a three-dimensional (3D) image (e.g., a DTS image) generated by combining the plurality of single-focus images.

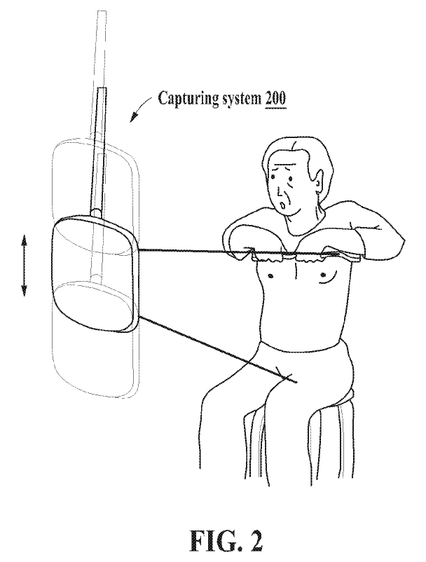

FIG. 2 is a diagram illustrating a capturing system using DTS technology, according to an embodiment.

Referring to FIG. 2, according to an embodiment, a capturing system 200 may be a capturing system of generating a DTS image. DTS may be technology of digitally reconstructing X-ray images to generate a 3D image. To generate the 3D image, the capturing system 200 may capture a subject from multiple angles. The generated 3D image may provide more stereoscopic information than conventional two-dimensional (2D) X-ray images.

The DTS may result in lower radiation exposure than computed tomography (CT). In addition, the DTS may have a higher capturing speed than the CT. Accordingly, the DTS may be widely used in medical imaging fields (e.g., breast cancer diagnosis) and industrial inspection (e.g., battery and semiconductor substrate inspection). The CT may capture the subject while a capturing device moves 360 degrees around the subject, whereas the DTS allows a capturing device to capture the subject within limited angles. Accordingly, the DTS may generate the 3D image by combining images captured within limited angles. A 3D DTS image generated based on the images captured within limited angles may be a tomographic image of a specific depth. Accordingly, the DTS image may have limitations in expressing the structure of a 3D subject. In addition, the DTS image may have difficulty achieving high resolution.

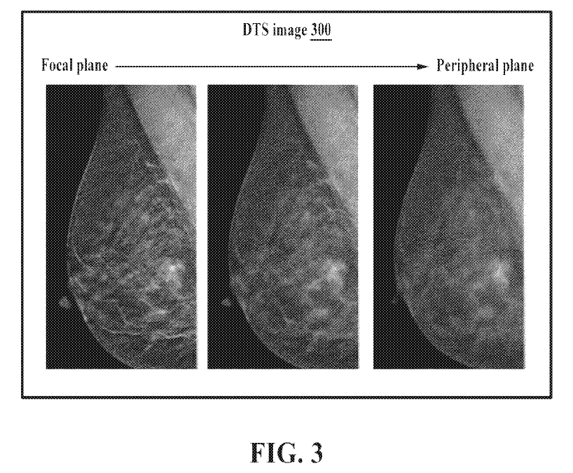

FIG. 3 is a diagram illustrating a DTS image according to an embodiment.

Referring to FIG. 3, according to an embodiment, a DTS image 300 may be a slice image focused on a specific depth. For example, the DTS image 300 may be a slice image focused on a specific depth generated by synthesizing a plurality of single-focus images. The DTS image 300 may include a focal plane and a peripheral plane. The focal plane may be a cross-section in which a structure (e.g., tissues to be observed) at a specific depth is most clearly visible. Accordingly, tissues or lesions located at a specific depth may be clearly observed in the focal plane. For example, the focal plane may clearly reveal the shape (or border) of lesions. The peripheral plane may be the DTS image 300 reconstructed at a depth different from the specific depth of the focal plane. The peripheral plane may be an out-of-focus image since the peripheral plane is reconstructed at the depth different from the specific depth of the focal plane. Since the peripheral plane is out of focus, the peripheral plane may be a cross-section in which a structure (e.g., tissues to be observed) appears blurry.

The focal plane may have less noise than the peripheral plane. Accordingly, the sharpness of the focal plane may be higher than that of the peripheral plane. The focal plane may have less overlap with surrounding tissues of the tissues to be observed compared to the peripheral plane. The peripheral plane may include, unlike the focal plane, a structure (e.g., tissues) located at a different depth that overlaps with the tissues to be observed.

The DTS image 300 may not be complete 3D data like a CT image. The DTS image 300 may be a 2D slice image focused on a specific depth. The DTS image 300 may be an image that lacks depth information other than the specific depth. Accordingly, the DTS image 300 may be an image in which structural distortion has occurred during the reconstruction process. The DTS image 300 may exhibit blurring in an area outside the focal plane. Due to blurring, image quality of the DTS image 300 may be degraded. Due to these issues, it may be difficult to observe fine structures using the DTS image 300. For example, when a DTS image is used in medical imaging, it may be difficult to observe fine lesions within the DTS image. Alternatively, when a DTS image is used in industrial inspection, it may be difficult to identify fine defects within the DTS image.

By generating a multi-focus image based on a plurality of DTS images, the issue of image quality degradation of the DTS image may be solved.

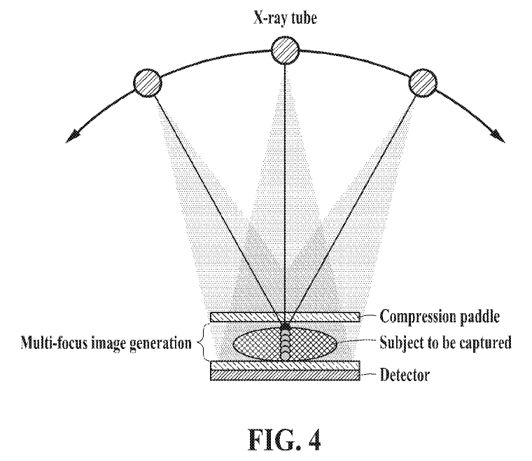

FIG. 4 is a diagram illustrating a method of generating a multi-focus image, according to an embodiment.

Referring to FIG. 4, according to an embodiment, an X-ray tube, a compression paddle, and a detector may be required to generate a plurality of single-focus images. The plurality of single-focus images may be required to generate a multi-focus image.

The X-ray tube may capture images of a subject. For example, the X-ray tube may move within limited angles to capture the subject. The results captured by the X-ray tube may be single-focus images.

The compression paddle may be used to compress the subject. For example, the compression paddle may flatten tissues of the subject by compressing the subject. The compression paddle may reduce the thickness of the tissues by flattening the tissues of the subject. The compression paddle may prevent the tissues from overlapping by reducing the thickness of the tissues. Accordingly, the structure of the tissue may be clearly displayed in the single-focus images. The compression paddle may be used to stabilize the subject during capturing to prevent movement.

The detector may be a device that generates an image. For example, the detector may generate a single-focus image. The detector may detect X-rays that have passed through the subject. The detector may convert the detected X-rays into a digital signal. The detector may process the digital signal, which is the result of conversion, to generate the single-focus image. In the generated single-focus image, areas where a lot of X-rays passed through (e.g., areas without bones) may be expressed to be bright, and areas where less X-rays passed through (e.g., bones) may be expressed to be dark.

DTS images may be obtained by capturing images using the X-ray tube. The DTS images may include the plurality of single-focus images. The image generation module 140 may generate the multi-focus image based on the plurality of single-focus images.

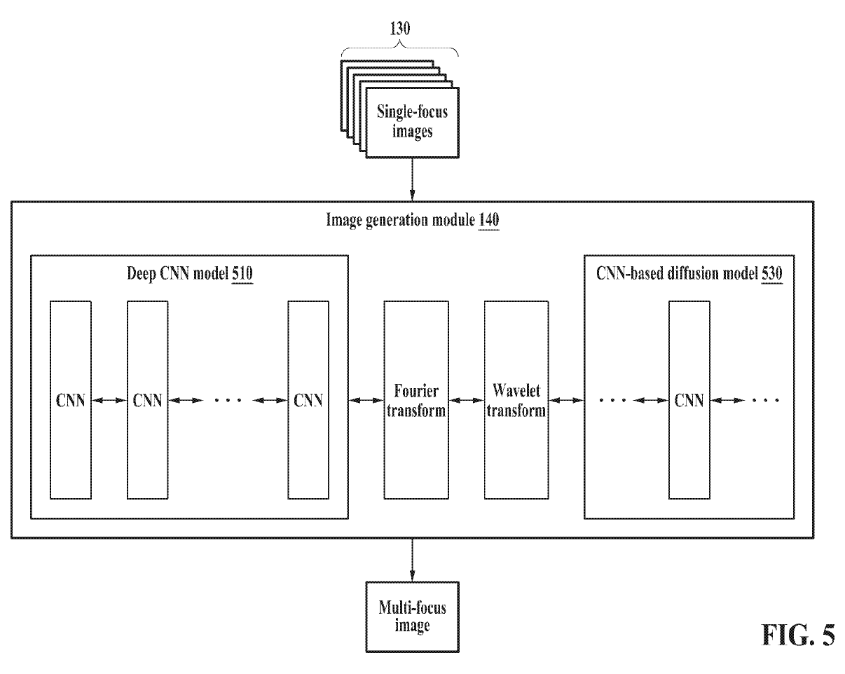

FIG. 5 is a diagram illustrating an image generation module according to an embodiment.

Referring to FIG. 5, according to an embodiment, the image generation module 140 may include a deep CNN model 510, a Fourier transform, a wavelet transform, and a CNN-based diffusion model 530. The image generation module 140 may obtain a plurality of single-focus images 130 as input. The plurality of single-focus images 130 may be input as basic data for reconstructing a 3D image. The plurality of single-focus images 130 may be DTS images obtained from various angles. The plurality of single-focus images 130 may provide initial data for extracting depth information. The image generation module 140 may generate the multi-focus image based on the plurality of single-focus images.

The image generation module 140 may perform preprocessing on the plurality of single-focus images 130. For example, the image generation module 140 may remove blur and noise from the plurality of single-focus images 130. The image generation module 140 may remove blur and noise from the plurality of single-focus images 130 using noise filtering, based on an artificial intelligence model, and sharpness enhancement algorithms. The artificial intelligence model may be generated by machine learning. Such learning may be performed by, for example, the electronic device 100 in which artificial intelligence is performed, or performed via a separate server. Learning algorithms may include, but are not limited to, e.g., supervised learning, unsupervised learning, semi-supervised learning, or reinforcement learning. The artificial intelligence model may include a plurality of artificial neural network layers. An artificial neural network may include, for example, a deep neural network (DNN), a CNN, a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The artificial intelligence model may additionally or alternatively include a software structure other than the hardware structure. The image generation module 140 may optimize input data by performing preprocessing on the plurality of single-focus images 130.

The image generation module 140 may obtain the depth information for the plurality of single-focus images 130 through the deep CNN model 510. The image generation module 140 may input the plurality of single-focus images 130 to the deep CNN model 510. The image generation module 140 may extract a spatial feature from the plurality of single-focus images 130 through the deep CNN model 510. The image generation module 140 may obtain the depth information for the plurality of single-focus images 130 based on the extracted spatial feature.

The image generation module 140 may apply the Fourier transform and the wavelet transform to the depth information for the plurality of single-focus images 130. The image generation module 140 may quantify phase shift between focuses by applying the Fourier transform and the wavelet transform to the depth information for the plurality of single-focus images 130. The image generation module 140 may obtain depthwise focus information for the plurality of single-focus images 130 based on a value in which the phase shift between focuses for the plurality of single-focus images 130 is quantified. The image generation module 140 may use a deep learning model to naturally achieve the phase shift between focuses. The deep learning model may include vision transformer (ViT), swin transformer, and video transformer.

The image generation module 140 may generate a multi-focus image through a CNN-based diffusion model. The image generation module 140 may input the depthwise focus information for the plurality of single-focus images to the CNN-based diffusion model. The image generation module 140 may generate the multi-focus image in which transitions between depthwise focuses are naturally achieved by using the CNN-based diffusion model.

The image generation module 140 may perform post-processing and correction on the generated multi-focus image. For example, the image generation module 140 may remove blur and noise from the generated multi-focus image. The image generation module 140 may perform fine-tuning on the generated multi-focus image. For example, the image generation module 140 may perform brightness adjustment, contrast adjustment, and saturation adjustment on the generated multi-focus image.

The image generation module 140 may restore the depthwise focus information based on the plurality of single-focus images. The image generation module 140 may solve the issue of image quality degradation of DTS images by generating the multi-focus image.

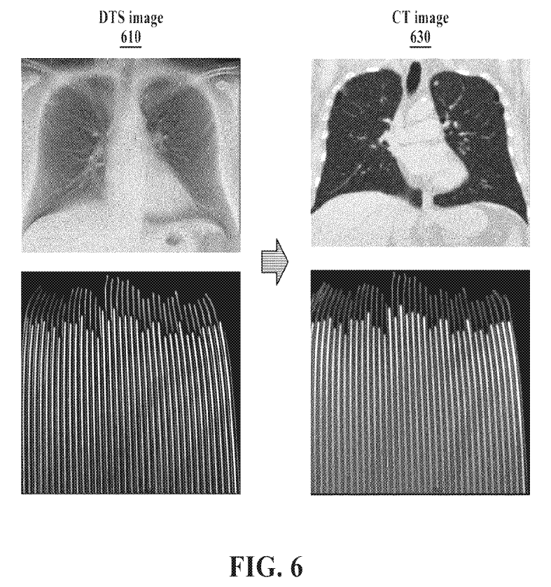

FIG. 6 is a diagram illustrating a DTS image and a CT image according to an embodiment.

Referring to FIG. 6, according to an embodiment, a CT image 630 may have a higher image quality (or resolution) than a DTS image 610. Accordingly, the CT image 630 may provide more precise 3D in-depth information than the DTS image 610.

CT may be technology of capturing images while a capturing device moves 360 degrees around a subject to be captured. Accordingly, the CT image 630 may provide complete 3D information for the subject to be captured. On the contrary, DTS may be a technique in which a capturing device moves within limited angles to capture the subject. The DTS image 610 may be suitable for analyzing a structure located at a specific depth of focus. A multi-focus image may be generated for the DTS image 610 to utilize the DTS image 610 without any limitation on a specific depth.

A plurality of single-focus images may be DTS images. The multi-focus image may be generated based on the plurality of single-focus images. The generated multi-focus image may have a similar level of image quality to the CT image 630.

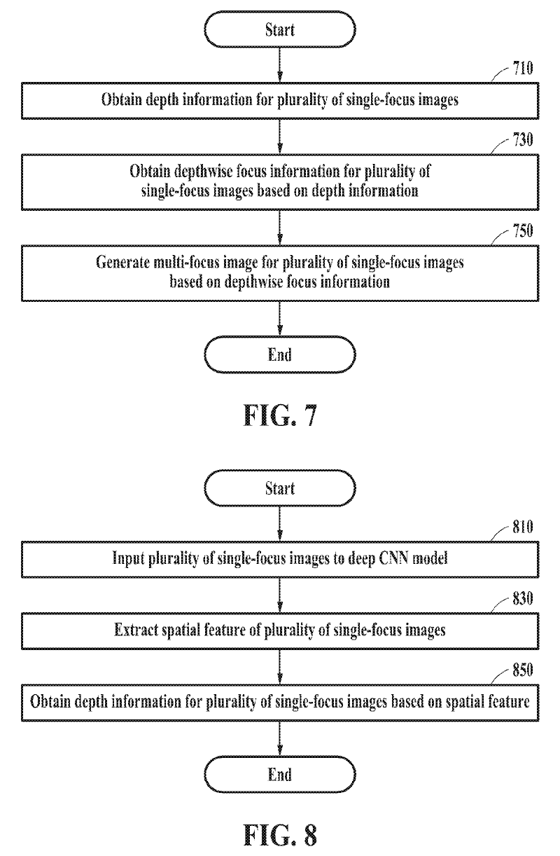

FIG. 7 is a flowchart illustrating a method of generating an image according to an embodiment.

Referring to FIG. 7, according to an embodiment, operations 710 to 750 may be operations performed by the electronic device 100 including the image generation module 140, described with reference to FIGS. 1 to 6.

In operation 710, the electronic device 100 may obtain depth information for a plurality of single-focus images.

In operation 730, the electronic device 100 may obtain depthwise focus information for the plurality of single-focus images based on the depth information.

In operation 750, the electronic device 100 may generate a multi-focus image for the plurality of single-focus images based on the depthwise focus information.

Operations 710 to 750 may be performed sequentially, but embodiments are not limited thereto. For example, two or more operations may be performed in parallel. Operations 710 to 750 may be substantially the same as the method of generating an image, according to an embodiment, performed by the electronic device 100, described with reference to FIGS. 1 to 6.

FIG. 8 is a flowchart illustrating a method of obtaining depth information for a plurality of single-focus images, according to an embodiment

Referring to FIG. 8, according to an embodiment, the image generation module 140, described with reference to FIGS. 1 to 7, may obtain depth information for a plurality of single-focus images.

In operation 810, the image generation module 140 may input the plurality of single-focus images to a deep CNN model.

In operation 830, the image generation module 140 may extract a spatial feature of the plurality of single-focus images through the deep CNN model.

In operation 850, the image generation module 140 may obtain depth information for the plurality of single-focus images based on the spatial feature.

Operations 810 to 850 may be performed sequentially, but embodiments are not limited thereto. For example, two or more operations may be performed in parallel. Operations 810 to 850 may be substantially the same as the method of obtaining depth information for a plurality of single-focus images, according to an embodiment, performed by the image generation module 140, described with reference to FIGS. 1 to 7.

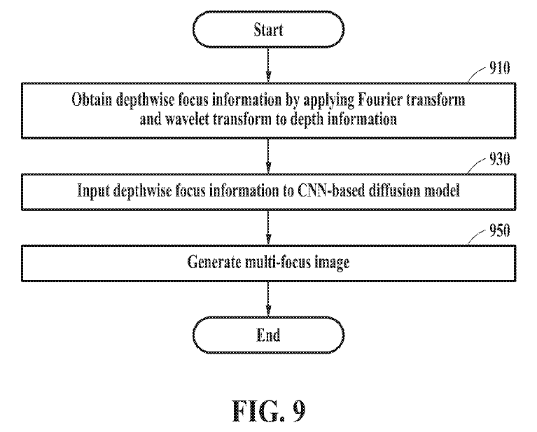

FIG. 9 is a flowchart illustrating a method of generating a multi-focus image, according to an embodiment.

Referring to FIG. 9, according to an embodiment, the image generation module 140, described with reference to FIGS. 1 to 8, may generate a multi-focus image for a plurality of single-focus images.

In operation 910, the image generation module 140 may obtain depthwise focus information by applying a Fourier transform and a wavelet transform to depth information for the plurality of single-focus images.

In operation 930, the image generation module 140 may input the depthwise focus information to a CNN-based diffusion model.

In operation 950, the image generation module 140 may generate the multi-focus image through the CNN-based diffusion model.

Operations 910 to 950 may be performed sequentially, but embodiments are not limited thereto. For example, two or more operations may be performed in parallel. Operations 910 to 950 may be substantially the same as the method of generating a multi-focus image, according to an embodiment, performed by the image generation module 140, described with reference to FIGS. 1 to 8.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The units described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A method of generating an image, the method comprising:
obtaining depth information for a plurality of single-focus images;
obtaining depthwise focus information for the plurality of single-focus images based on the depth information; and
generating a multi-focus image for the plurality of single-focus images based on the depthwise focus information.

2. The method of claim 1, wherein
the obtaining of the depth information for the plurality of single-focus images comprises:
extracting a spatial feature from the plurality of single-focus images by inputting the plurality of single-focus images to a deep convolutional neural network (CNN) model; and
obtaining the depth information for the plurality of single-focus images based on the spatial feature.

3. The method of claim 1, wherein
the obtaining of the depthwise focus information for the plurality of single-focus images based on the depth information comprises obtaining the depthwise focus information by applying a Fourier transform and a wavelet transform to the depth information.

4. The method of claim 1, wherein
the generating comprises generating the multi-focus image by inputting the depthwise focus information to a convolutional neural network (CNN)-based diffusion model.

5. The method of claim 1, wherein
each of the plurality of single-focus images is captured from a different angle of a captured subject.

6. The method of claim 1, wherein
the plurality of single-focus images is digital tomosynthesis (DTS) images.

7. The method of claim 1, further comprising:
preprocessing the plurality of single-focus images by removing blur and noise of the plurality of single-focus images.

8. The method of claim 1, further comprising:
removing blur and noise of the multi-focus image.

9. A non-transitory computer-readable storage medium storing instructions that, when executed by a processor, cause the processor to perform the method of claim 1.

10. An electronic device for generating an image, the electronic device comprising:
a processor; and
a memory configured to store instructions,
wherein the instructions, when executed by the processor, cause the electronic device to:
obtain depth information for a plurality of single-focus images;
obtain depthwise focus information for the plurality of single-focus images based on the depth information; and
generate a multi-focus image for the plurality of single-focus images based on the depthwise focus information.

11. The electronic device of claim 10, wherein
the instructions cause the electronic device to:
extract a spatial feature from the plurality of single-focus images by inputting the plurality of single-focus images to a deep convolutional neural network (CNN) model; and
obtain the depth information for the plurality of single-focus images based on the spatial feature.

12. The electronic device of claim 10, wherein
the instructions cause the electronic device to obtain the depthwise focus information by applying a Fourier transform and a wavelet transform to the depth information.

13. The electronic device of claim 10, wherein
the instructions cause the electronic device to generate the multi-focus image by inputting the depthwise focus information to a convolutional neural network (CNN)-based diffusion model.

14. The electronic device of claim 10, wherein
each of the plurality of single-focus images is captured from a different angle of a captured subject.

15. The electronic device of claim 10, wherein
the plurality of single-focus images is digital tomosynthesis (DTS) images.

16. The electronic device of claim 10, wherein
the instructions cause the electronic device to preprocess the plurality of single-focus images by removing blur and noise of the plurality of single-focus images.

17. The electronic device of claim 10, wherein
the instructions cause the electronic device to remove blur and noise of the multi-focus image.
